(19) United States
(12) Patent Application Publication
(10) Pub. No.: US 2010/0112859 A1
(43) Pub. Date: May 6, 2010

(54) SHIELDED CONNECTOR SYSTEM

(76) Inventors: Barry L. OLAWSKY, Houston, TX (US); Charles Jenkins, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/261,711

(22) Filed: Oct. 30, 2008

(51) Int. Cl. H01R 13/648

(52) U.S. Cl. 439/607.01

(57) ABSTRACT

A system comprises a cable connector, a board-mounted receptacle to which the cable connector is electrically coupled, and an electromagnetic interference (“EMI”) shield that is disposed about the board-mounted receptacle. The EMI shield has an opening through which the cable connector is inserted to be coupled to the board-mounted receptacle. The EMI shield covers a portion of a board, to which the board-mounted receptacle is mounted, and a surface of the EMI shield adjacent to the board covers at least 11% of the portion.

### BACKGROUND

Considering data transmission hardware, connectors are devices that join electrical circuitry and reside at data transfer junctures. Connectors can be divided into two categories: internal connectors and external connectors. Internal connectors are so named because of their use when the transfer juncture is housed because stray pressure, e.g., inadvertently pulling on a cable that terminates in the connector, is unlikely. As such, internal connectors are designed with a low profile and small size that is well suited to data transmission applications where space is limited. External connectors are so named because of their use when the transfer juncture is in the open and subject to stray pressure. As such, external connectors are designed for physical connection strength, which typically makes the external connectors larger and bulkier especially considering housing space need not be conserved. External connectors are also designed with electromagnetic interference (“EMI”) shielding to prevent data corruption. As such, external connectors cannot be used if spatial efficiency is desired, and internal connectors cannot be used if shielding is desired.

The Mini Multilane data transmission hardware is designed to satisfy the needs for gigabit serial data transmission applications. Design goals are minimization of crosstalk and minimum transmission line impedance discontinuity across the connector interface at speeds of up to 10 Gigabits/second on two rows of contacts. Though Mini Multilane connectors are designed for a 100 ohm environment, the connectors will function at other impedance levels. The Mini Multilane standard for connectors is based on card edge style contacts. This connection scheme may be used in multiple locations within a cabling environment including locations typically calling for an internal connectors and external connectors. The Mini Multilane standard relies on a receiving body and paddle card, which are the primary elements to construct connectors. As an example of the difference in design for the internal Mini Multilane connector and the external Mini Multilane connector, the internal connector is unshielded and has a connection strength that withstands at least 10 lbf of stress, whereas the external connector is shielded and withstands at least 20 lbf of stress.

### BRIEF DESCRIPTION OF THE DRAWINGS

For a detailed description of exemplary embodiments of the invention, reference will now be made to the accompanying drawings in which:

FIG. 1 illustrates a perspective view of a system comprising a cable connector, an electromagnetic interference (“EMI”) shield, a board-mounted receptacle, and a board in accordance with at least some illustrative embodiments;

FIG. 2 illustrates a perspective view of the system without the shield disposed about the receptacle, and with the connector uncoupled from the receptacle in accordance with at least some illustrative embodiments;

FIG. 3 illustrates a side view of the system in accordance with at least some illustrative embodiments;

FIG. 4 illustrates a perspective view of the lower portion of the cable connector shielding in isolation in accordance with at least some illustrative embodiments;

FIG. 5 illustrates a perspective view of the upper portion of the cable connector shielding in isolation in accordance with at least some illustrative embodiments;

FIG. 6 illustrates a perspective view of the shield with the surface adjacent to the board face up in accordance with at least some illustrative embodiments;

FIG. 7 illustrates a perspective view of the shield with the surface adjacent to the board face down in accordance with at least some illustrative embodiments; and

FIG. 8 illustrates the system further comprising a computer in accordance with at least some illustrative embodiments.

### NOTATION AND NOMENCLATURE

Certain terms are used throughout the following claims and description to refer to particular components. As one skilled in the art will appreciate, different entities may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean an optical, wireless, indirect electrical, or direct electrical connection. Thus, if a first device couples to a second device, that connection may be through a direct electrical connection, through an indirect electrical connection via other devices and connections, through an optical connection, or through a wireless connection. Additionally, the term “system” refers to a collection of two or more hardware components, and may be used to refer to an electronic device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Although any type of internal and external connectors are within the scope of this disclosure, the Mini Multilane connectors will be discussed for simplicity and clarity. The present system contains the benefits of both the 360 degree shielding of external connectors and the space conserving attributes of internal connectors by shielding the internal connector and strengthening a shield at the transfer juncture. Moreover, the system is designed to be backwards compatible with unshielded internal connectors as well.

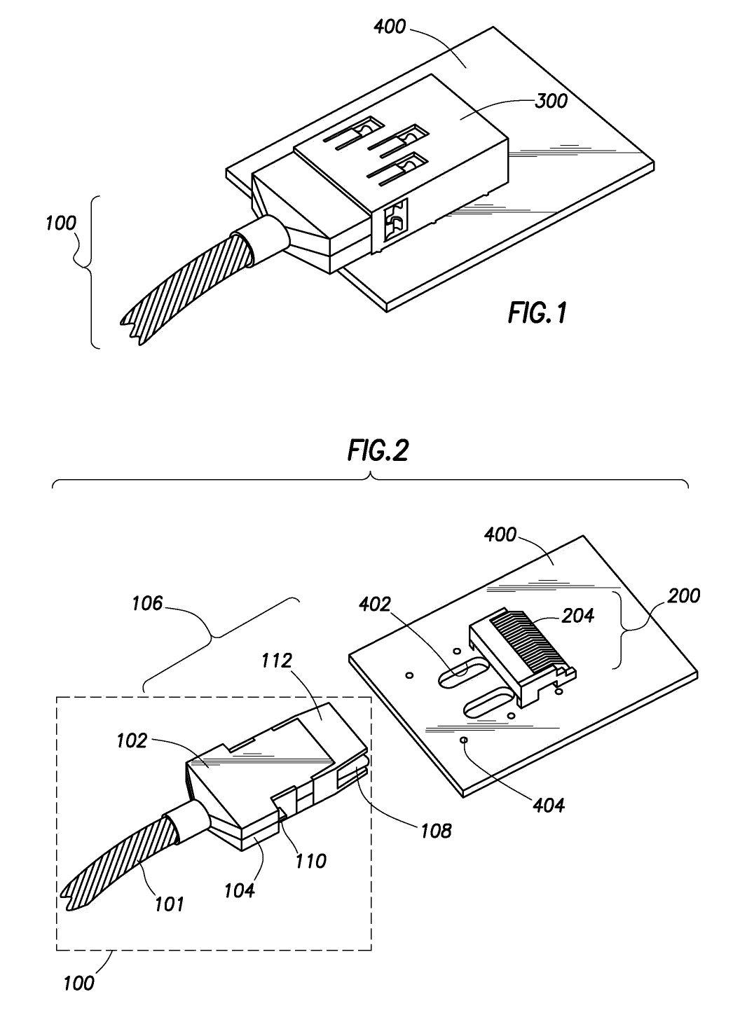

FIG. 1 illustrates a perspective view of an illustrative system comprising a cable connector 100, an electromagnetic interference (“EMI”) shield 300, and a board 400. FIG. 2 illustrates a perspective view of the system without the shield 300 disposed about a receptacle 200 and with the connector 100 uncoupled from the receptacle 200. The system also comprises a board-mounted receptacle 200, which is obscured, and to which the connector 100 is electrically coupled. The figure illustrates the connector 100 fully inserted into the shield 300. As such, the connector 1 00 is partially obscured by the shield 300. In addition to shielding EMI, the shield 300 provides guidance and support for the connector 100, and absorbs mechanical stress imposed by insertion and removal of the connector 100 into the receptacle 200.

In at least one embodiment, the cable connector 100 comprises a cable portion 101 and a connector portion 106. Preferably, the cable connector 100 is a Mini Multilane internal connector that comprises a paddle card 108; however any type of connector is within the scope of this disclosure. The paddle card 108 comprises contacts that correspond to contacts 204 on the receptacle 200 for electrical coupling. Upon coupling, the paddle card 108 is at least partially enclosed by the receptacle 200. Preferably, the cable connector 100 comprises a housing portion 112 that houses the paddle card. In at least one embodiment, the housing portion is made of plastic, but any material suitable for housing is within the scope of this disclosure.

In at least one embodiment, the cable connector 100 is fully or partially EMI shielded. Preferably, EMI shielding about the cable connector 100 comprises an upper portion 102 disposed on the top side of the housing portion 112 and a lower portion 104 disposed on the bottom side of the housing portion 112 as illustrated, and the shielding is disposed at least partially about the housing portion 112 and at least partially about the cable portion 101. In at least one embodiment, the upper portion 102 and lower portion 104 are made of sheet metal, but any material and shape suitable for shielding EMI is within the scope of this disclosure. The cable connector 100 also comprises securing members 110 on the left and right sides of the connector portion 106 as illustrated to secure the cable connector 100 to the shield 300 via a corresponding securing notch 314 (FIG. 3). Preferably, the securing members 110 are of the same plastic as the housing portion 11 2, but any material and shape suitable for support is within the scope of this disclosure. As illustrated, the securing members 110 are rectangular in shape. Preferably, the board 400 comprises a circuit board. In at least one embodiment, the circuit board comprises traces that couple to contacts on the paddle card 108 via the contacts 204 on the receptacle 200.

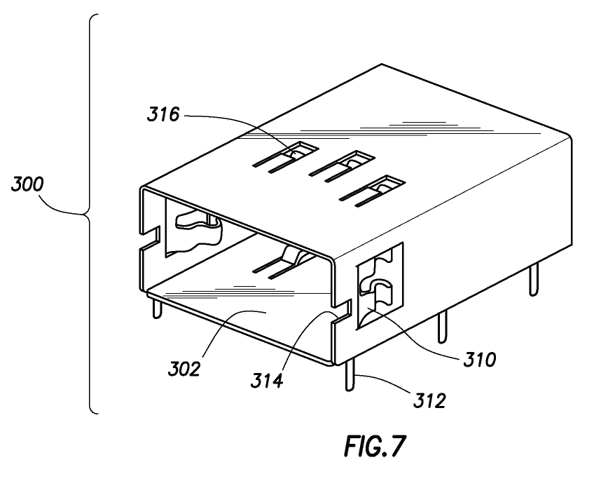

Preferably, the receptacle 200 is a right angle receptacle; however, any type of receptacle is within the scope of this disclosure. A right angle design is for use with boards where the mating direction is parallel to the plane of the board 400. Another type of design, the “straight-body” design, is for use with boards where the mating direction is perpendicular to the plane of the board 400. The receptacle 200 comprises a set of contacts 204 that electrically couple the contacts on the paddle card 108 to traces on the board 400, and the receptacle 200 is mounted to the board 400 via pegs 202 (obscured). The board 400 comprises support holes 402, shield holes 404, and peg holes 406 (obscured). Support holes 402 are used with support members 308 (FIG. 7) on the shield 300, shield holes 404 are used with shield stabilizers 312 (FIG. 7) on the shield 300, and peg holes are used with pegs 202 (FIG. 3) on the receptacle 200.

FIG. 3 illustrates a side view of the system with the shield 300 illustrated in translucent form so that the profile of the receptacle 200 may be seen. The receptacle 200 comprises pegs 202, one on right side of the receptacle 200 and one on the left, which mate with peg holes 406 to stabilize the receptacle 200 on the board 400. Preferably, the pegs 202 and the peg holes 406 are square, and the pegs 202 are made of the same material as the receptacle 200, but any shape, number, or material suitable for mounting is within the scope of this disclosure.

Similarly, shield stabilizers 312, eight in number in some embodiments, are hollow rectangular protrusions from the shield 300 that mate with shield holes 404 to stabilize the shield 300 on the board 400. Preferably, the shield stabilizers 312 are made of the same material as the shield 300, but any shape, number, or material suitable for securing is within the scope of this disclosure. The shield 300 preferably comprises securing notches 314, one on the left and right side of the shield 300, which accept the securing members 110 of the connector 100. When coupled, the notches 314 and the securing members 110 prevent stray pressures from moving the connector 100 perpendicular to the plane of the board 400 and prevent the connector 100 from exerting excess pressure on the receptacle 200 in the mating direction. Preferably, the notches 314 comprise rectangular indentations in the left and right sides of the shield 300, but any shape or location suitable for securing is within the scope of this disclosure. The shield 300 also preferably comprises left and right support members 310. The left and right support members 310 contact the sides of the connector portion 106 when the connector portion 106 enters the shield 300 such that the support members exert force on the connector portion 106 toward the inside of the shield 300. Such force guides the connector 100 to correctly mate with the receptacle 200 and stabilizes the final connection by preventing excess motion of the connector portion 106 parallel to the plane of the board 400.

As illustrated, each of the left and right support members 310 comprises two finger-shaped members 310a, 310b cut out in relief from the corresponding side of the shield 300. The two members 310a, 310b that make up one support member 310 are coupled together and coupled to the main body of the shield 300 in a location near to the securing notches 314. Each of these members is curved toward the inside of the shield to provide the securing force described above. In at least one embodiment, the left and right support members 310 are displaced toward the outside of shield 300 when the connector 100 is coupled to the receptacle 200. Preferably, the left and right support members are made of the same material as the rest of the shield 300, but any suitable securing material, location, and number of left and right supporting members 310 is within the scope of this disclosure.

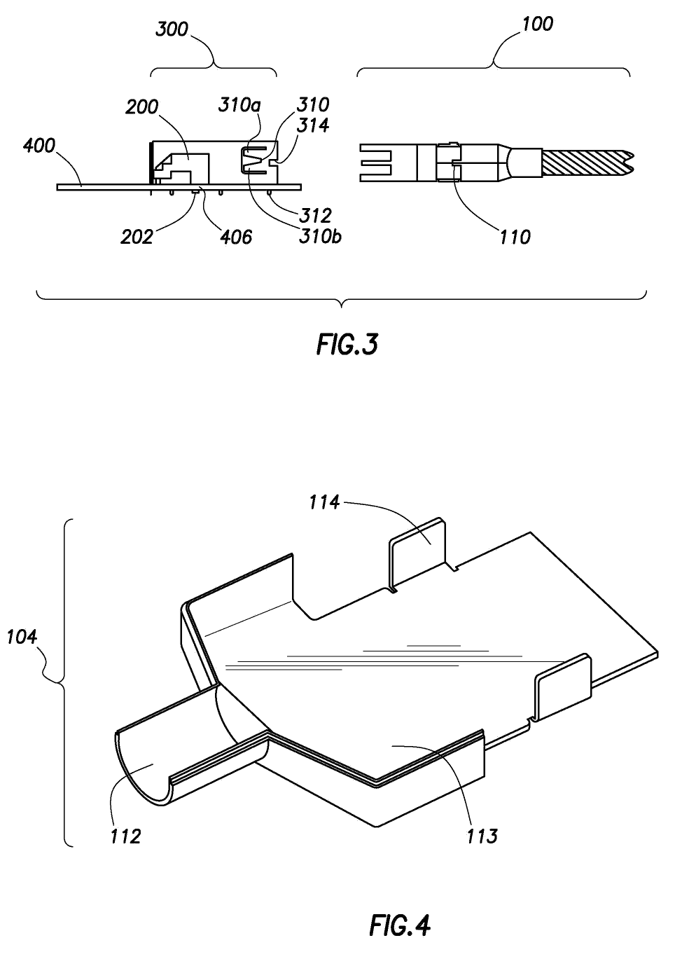

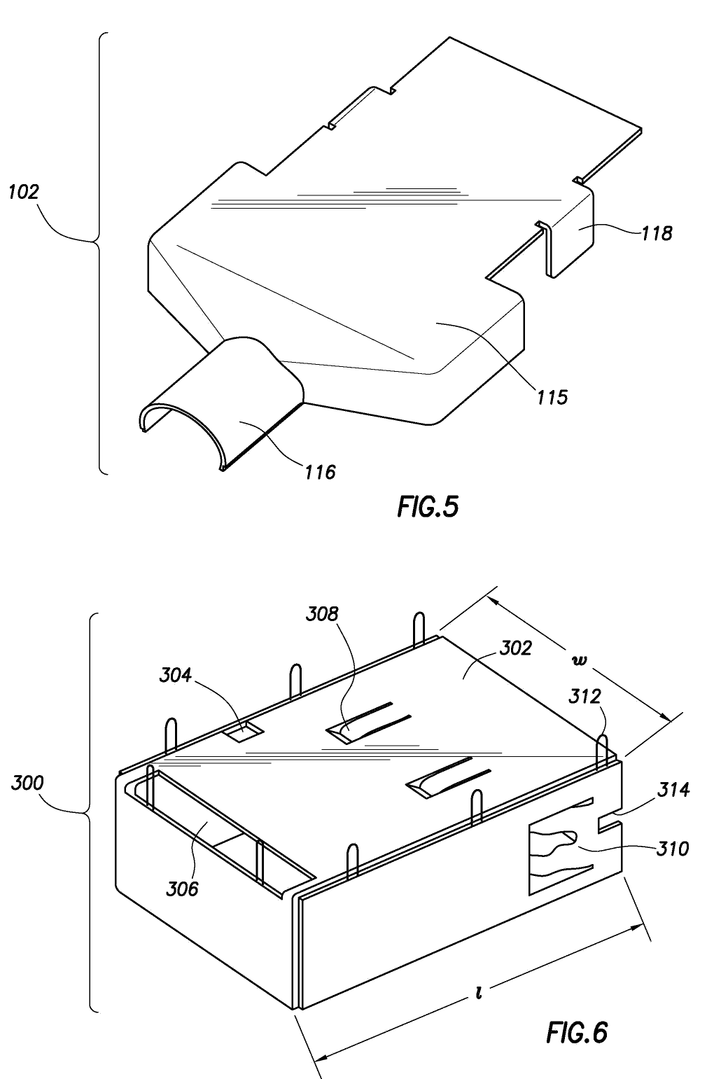

FIG. 4 illustrates a perspective view of the lower portion 104 of the cable connector 100 shielding in isolation, and FIG. 5 illustrates a perspective view of the upper portion 102 of the connector 100 shielding in isolation. Preferably, the lower portion 104 is identical to the upper portion 102, though non-identical portions are within the scope of this disclosure. In at least one embodiment, each portion 102,104 comprises a cable shielding portion 112, 116. Preferably, each cable shielding portion 112, 116 is semi-cylindrical such that a cylinder is formed around the cable 101 when the cable shielding portions 112, 116 are coupled. In at least one embodiment, cable shielding portions 112, 116 form a shield at least partially around the cable 101 of the connector 100. Each upper and lower portion 102, 104 comprises a rectangular portion 113, 115 coupled to the cable shielding portion 112, 116. As illustrated, the rectangular portions 113,115 surround the connector 100 on all sides from the cable until the securing members 110. Afterwards, the rectangular portions 113, 115 cover the top and bottom of the connector 100, with the exceptions of the tabs 114, 118. Preferably, the tabs 114, 118 comprise extensions of the rectangular portions 113, 115 that cover the sides of the connector 100 such that shielding is provided despite holes in the shield 300 designed to accommodate the left and right support members 310. Preferably the tabs 114, 118 are of a size and shape sufficient to correspond to such holes although any size, shape, and number of tabs are within the scope of this disclosure. Preferably, the rectangular portions 113, 115 extend to cover holes in the shield 300 designed to accommodate the top 316 and bottom 308 support members, discussed below.

FIG. 6 illustrates a perspective view of the shield 300 with the bottom surface 302 adjacent to the board 400 face up. Preferably, the EMI shield is rectangular. In at least one embodiment, the EMI shield comprises sides and a bottom surface 302 of less than 0.089 inches thick. In at least one embodiment, the EMI shield comprises sides and a bottom surface 302 of less than 0.052 inches thick. Preferably, the EMI shield comprises sides and a bottom surface 302 of 0.01 inches thick. Preferably, the bottom surface 302 comprises peg holes 304, through which pegs 202 (seen in FIG. 3) of the receptacle 200 are used to mount the receptacle 200 to the board 400. As illustrated, the peg holes 304 are square, but any shape or number is within the scope of this disclosure. The bottom surface 302 also preferably comprises a contact hole 306 through which the contacts 204 of the receptacle 200 electrically couple to the board 400. As illustrated, the contact hole 306 is rectangular, but any shape or number is within the scope of this disclosure. In at least one embodiment, the contact hole 306 is large enough to accommodate the full form factor of the receptacle 200 as well as nearby elements used to gain access to the board 400, e.g., vias. As illustrated, the bottom surface 302 comprises bottom support members 308 that are displaced into the support holes 402 of the board 400 by the connector 100 when the connector 100 is coupled to the receptacle 200. Preferably, bottom support members 308 comprise a finger-shaped member cut out in relief from the bottom of the shield 300, much like the left and right support members 310 except having one “finger.” Each of these members is curved toward the inside of the shield 300 to provide a securing force to prevent excess motion of the connector 100 perpendicular to the board 400 when the connector 100 is coupled to the receptacle 200. Preferably, the bottom support members 308 are made of the same material as the rest of the shield 300, but any material, number, location, or shape suitable for support is within the scope of this disclosure.

As illustrated, eight shield stabilizers 312 protrude from the bottom of the shield 300, and the shield stabilizers 312 have a hollow rectangular shape. Preferably, the shield stabilizers 312 are made of the same material as the shield 300, but any number, shape, location, or material is within the scope of this disclosure. The shield stabilizers 312 mate with the shield holes 404 on the board 400 to stabilize the shield 300.

Preferably, the bottom surface 302 lies adjacent to the board 400 such that the bottom surface 302 covers a portion of the board 400. In at least one embodiment, the portion of the board 400 that is covered is equal to the surface area of the board underneath any part of the shield 300. Preferably, the bottom surface 302 covers at least 11% of the portion of the board 400 covered. For example, if the length, l, of the entire shield 300 is 29 mm and the width, w, of the entire shield 300 is 23 mm, then the surface area of the board 400 underneath any part of the shield is 300 is 667 mm². Therefore, the surface area of the bottom surface 302 is at least 73.37 mm², so that the bottom surface 302 can cover at least 11% of the board 400. However, any percentage is within the scope of this disclosure.

FIG. 7 illustrates a perspective view of the shield 300 with the surface 302 adjacent to the board 400 face down. The shield 300 preferably comprises top support members 316, which are similar to bottom support members 308, except that top support members 316, when displaced, are not displaced into holes in the board 400. In at least one embodiment, the shielding on the connector 100 is sufficient to cover the holes created by the top and bottom support members 308, 316 similar to the tabs 114, 118 being of sufficient size and location to cover the holes created by the left and right support members 310. As such, the system preferably provides EMI shielding in all directions.

Preferably, the shield 300 comprises an opening through which the connector 100 is inserted to be coupled to the receptacle 200. In at least one embodiment, in addition to the shielded connector 100 described above, the shield 300 also accepts an unshielded internal cable connector. Preferably, such an unshielded connector is a Mini Multilane unshielded connector. In at least one embodiment, the left and right support members 310, as well as the top and bottom support members 308, 316, provide support to the unshielded connector as well as the shielded connector.

In addition to the support members 308, 310, 316, there are many ways to further secure the connector 100 into the shield 300 including latches, keys, grooves, detents, etc., and each method of securing the connector 100 to the shield 300 and supporting the connection of the connector and the receptacle 200 is within the scope of this disclosure.

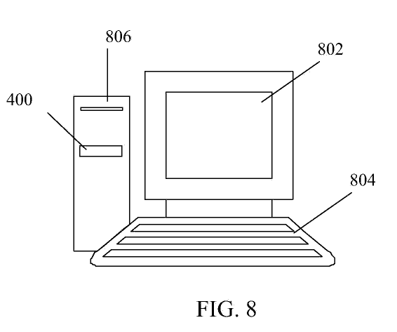

FIG. 8 illustrates the system further comprising a computer. In at least one embodiment, the computer comprises a display 802, an input device 804, and a chassis 806. Preferably, the user input device 804 is a keyboard. However, any method suitable for input is within the scope of this disclosure. For example, the input device comprises a computer mouse in at least one embodiment. Preferably, the chassis 806 houses the board 400, and the board 400 comprises a circuit board. The shield 300 and receptacle 200 are mounted to the board 400, and an internal Mini Multilane shielded connector 100 is coupled to the board 400 via the receptacle 200 and housed by the shield 300. The shielding prevents corruption of data by protecting against EMI in all directions. In at least one embodiment, the board 400 is a computer card designed to provide specific functionality to the system, e.g., a video card.

Other conditions and combinations of conditions will become apparent to those skilled in the art, including the combination of the conditions described above, and all such conditions and combinations are within the scope of the present disclosure. The above disclosure is meant to be illustrative of the principles and various embodiment of the present invention. Numerous variations and modifications will become apparent to those skilled in the art once the above disclosure is fully appreciated. It is intended that the following claims be interpreted to embrace all variations and modifications.

What is claimed is:

1. A system, comprising:
a cable connector;
a board-mounted receptacle to which the cable connector is electrically coupled; and
an electromagnetic interference (“EMI”) shield that is disposed about the board-mounted receptacle, the EMI shield having an opening through which the cable connector is inserted to be coupled to the board-mounted receptacle;
wherein the EMI shield covers a portion of a board, to which the board-mounted receptacle is mounted, and a surface of the EMI shield adjacent to the board covers at least 11% of the portion.

2. The system of claim 1, wherein the surface comprises at least one peg hole.

3. The system of claim 2, wherein the board-mounted receptacle comprises at least one peg.

4. The system of claim 3, wherein the board-mounted receptacle mounts to the board through the peg hole.

5. The system of claim 1, wherein the EMI shield is rectangular and comprises sides of less than 0.089 inches thick.

6. The system of claim 5, wherein the surface is less than 0.089 inches thick.

7. The system of claim 1, wherein the board-mounted receptacle comprises a set of contacts that electrically couple the board-mounted receptacle to the board through at least one contact hole in the surface.

8. The system of claim 1, wherein the board comprises at least one support hole, and the EMI shield comprises at least one support member that is displaced into the support hole by the cable connector when the cable connector is coupled to the board-mounted receptacle.

9. The system of claim 1, further comprising a computer coupled to the board.

10. The system of claim 1, wherein the board comprises a circuit board.

11. The system of claim 1, wherein the cable connector comprises a Mini Multilane internal connector.

12. The system of claim 11, wherein the cable connector is shielded.

13. The system of claim 12, wherein the EMI shield also accepts an unshielded Mini Multilane internal cable connector.

14. The system of claim 1, wherein the board-mounted receptacle is a right angle board-mounted receptacle.

15. An apparatus, comprising:
a rectangular housing comprising an opening through which an EMI shielded cable connector is inserted to be electrically coupled to a board-mounted receptacle, the housing disposed about the board-mounted receptacle, the housing shielding EMI;
wherein the housing covers a portion of a board, to which the board-mounted receptacle is mounted, and a side of the housing adjacent to the board covers at least 11% of the portion.

16. The apparatus of claim 15,
wherein the side comprises at least one contact hole through which a set of contacts of the board-mounted receptacle electrically couple to the board;
wherein the side comprises at least one peg hole through which at least one peg of the board-mounted receptacle mounts to the board; and
wherein the side comprises at least one support member that is displaced into at least one support hole of the board by the cable connector when the cable connector is coupled to the board-mounted receptacle.

17. The apparatus of claim 15, wherein the cable connector comprises a shielded Mini Multilane internal connector and the housing also accepts an unshielded Mini Multilane internal cable connector.

18. An apparatus, comprising:
a Mini Multilane internal cable connector comprising a connector portion and a cable portion; and
a first EMI shield disposed at least partially about the connector portion and at least partially about the cable portion;
wherein the cable connector electrically couples to a board-mounted receptacle through an opening in a second EMI shield that is disposed about the board-mounted receptacle; and
wherein the second EMI shield covers a portion of a board, to which the board-mounted receptacle is mounted, and a surface of the second EMI shield adjacent to the board covers at least 11% of the portion of the board.

19. The apparatus of claim 18, wherein the second EMI shield also accepts an unshielded Mini Multilane internal cable connector.

20. The apparatus of claim 18, wherein the first EMI shield comprises an upper portion disposed on a first side of the cable connector and a lower portion disposed on a second side of the cable connector.
